(19) United States
(12) Patent Application Publication
(10) Pub. No.: US 2010/0276949 A1
(43) Pub. Date: Nov. 4, 2010

(54) Inertia Balanced Vehicle Outside Door Handle

(75) Inventors: Houng Yue Chang, Canton, MI (US); Ching-Hui Chiang, Ann Arbor, MI (US); Ian S. Buckley, Swartz Creek, MI (US); Chu M. Tai, Troy, MI (US); Michael J. Wightman, Fowlerville, MI (US); Carolyn J. Thor, Lake Orion, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/549,859

(22) Filed: Aug. 28, 2009

Related U.S. Application Data
(60) Provisional application No. 61/175,078, filed on May 4, 2009.

(51) Int. Cl. E05B 3/00

(52) U.S. Cl. 292/336.3

(57) ABSTRACT

A door handle assembly for use with a vehicle door comprising a door paddle including an actuation arm, supported to pivot about a first axis such that lateral acceleration of the paddle and actuation arm relative to the door produces a first moment about the first axis, and masses engaged with the actuation arm and supported to pivot about a second axis, the masses being arranged such that lateral acceleration of the masses relative to the door produces a second moment about the first axis that is substantially equal in magnitude and opposite in direction to the first moment.

### CROSS REFERENCE TO RELATED APPLICATIONS

This application claims priority to and the benefit of U.S. Provisional Application No. 61/175,078, filed May 4, 2009, the full disclosure of which is incorporated herein by reference.

### BACKGROUND OF INVENTION

This invention relates generally to the door latching mechanism of a motor vehicle occupant entry door, and more particularly to counterbalanced, pivoting masses incorporated in the door latching mechanism.

The door paddle (sometimes called a pull bar or handle), located on the outside of the door, is manually gripped and pivoted to unlatch and open the door so that an occupant can enter the vehicle. During an impact event, the impact force, which can come from any direction, produces inertial forces acting on the components of the door handle assembly and has a tendency to unlatch the door. As a result of an impact event, the highest inertia force is applied to the door handle paddle and can be directed such that the inertia force may unlatch and open the door.

To reduce this tendency, a conventional handle design uses a high spring torque, which requires high unlatching effort to open the door, and a counter balanced mass located on top of a bell crank. The high unlatching effort produces the perception of low quality design.

If a door handle mechanism has a counter balanced mass on the top of the bell crank, the mass has the rotational axis perpendicular to the pull bar axis, and the inertial load from the pull bar cannot be balanced entirely. The conventional design cannot be tuned to have an inertia load capacity (usually referred to as a high G-load capacity) due to rotational motion of the mass.

A need exists in the industry for a door whose handle components have a high G-load capacity, so that the door remains latched during impact. Preferably the door handle components would require low unlatching effort, thereby indicating high quality design and manufacture.

### SUMMARY OF INVENTION

A door handle assembly for use with a vehicle door comprising a door paddle including a actuation arm, supported to pivot about a first axis such that lateral acceleration of the paddle and actuation arm relative to the door produces a first moment about the first axis, and masses engaged with the actuation arm and supported to pivot about a second axis, the masses being arranged such that lateral acceleration of the masses relative to the door produces a second moment about the first axis that is substantially equal in magnitude and opposite in direction to the first moment.

The vehicle outside door handle requires low unlatching effort, provides high G-load capacity in any direction, and reduces latching system cost.

### BRIEF DESCRIPTION OF DRAWINGS

FIG. 1 is a perspective view of a door handle assembly according to a first embodiment.

FIG. 2 is a perspective view of a door handle assembly according to a second embodiment.

FIG. 3 is a top view of the door handle assembly of FIG. 2, with the handle in the open position.

### DETAILED DESCRIPTION

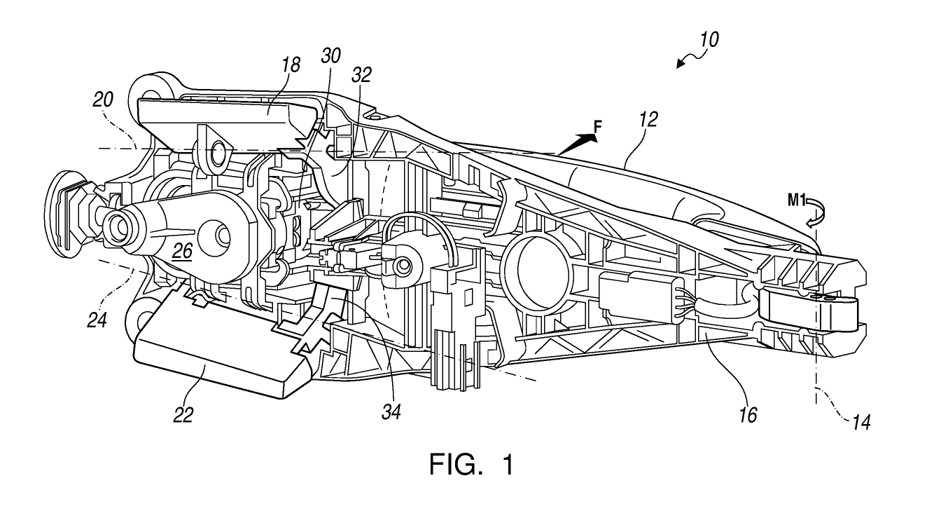

FIG. 1 shows an inboard view of a first embodiment of a door handle assembly 10 for a vehicle side door, in which the door paddle 12 is pivoted outboard about its pivot axis 14. A bracket 16, which is bolted to the inside of the door, supports the door paddle 12 at axis 14, an upper mass 18 at its pivot axis 20, and a lower mass 22 at its pivot axis 24. A key cylinder lever 26 rotates in response to rotation of a door key to lock and unlock the door.

An actuation arm 30, secured to door paddle 12 and extending through an opening in bracket 16, is continually engaged by arms 32, 34 formed integrally on the two masses 18, 22, respectively.

In operation, when the door paddle is pulled, actuation arm 30 moves outboard from the position shown in FIG. 1, which causes mass 18 to pivot about axis 20 downward and inboard, and mass 22 to pivot about axis 24 upward and inboard. While the door paddle 12 is accelerated, masses 18 and 22 apply forces through the door paddle actuation arm 30 such that those forces produce a balanced moment about axis 14 when viewed as in FIG. 1.

In the event of a vehicle impact event, lateral acceleration of the door paddle 12 relative to the bracket 16 produces an outboard directed inertia force F on the door paddle and a clockwise moment M1 about axis 14. Lateral acceleration also produces outboard inertia force on masses 18, 22, which pivots the masses outboard about axes 20, 24, respectively, applies an inboard reaction on actuation arm 30 and a counterclockwise moment about axis 14, which is balanced by the clockwise moment M1 produced by outboard inertia force on the door paddle 12. Because these moments are equal in magnitude and opposite in direction, the door paddle 12 remains stationary. The counterbalanced masses 18, 22 are arranged such that they cancel each other's vertical inertia and produce very high G-force capacity in any direction of the inertia forces.

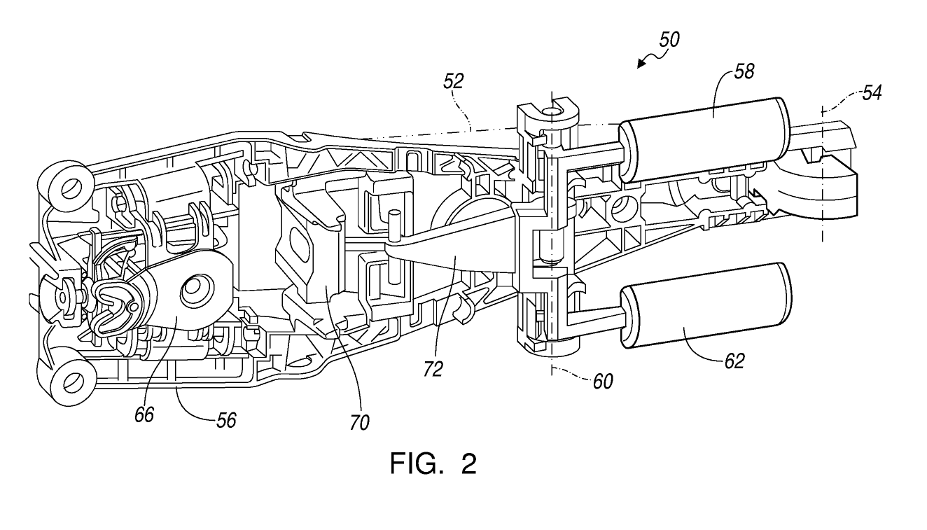

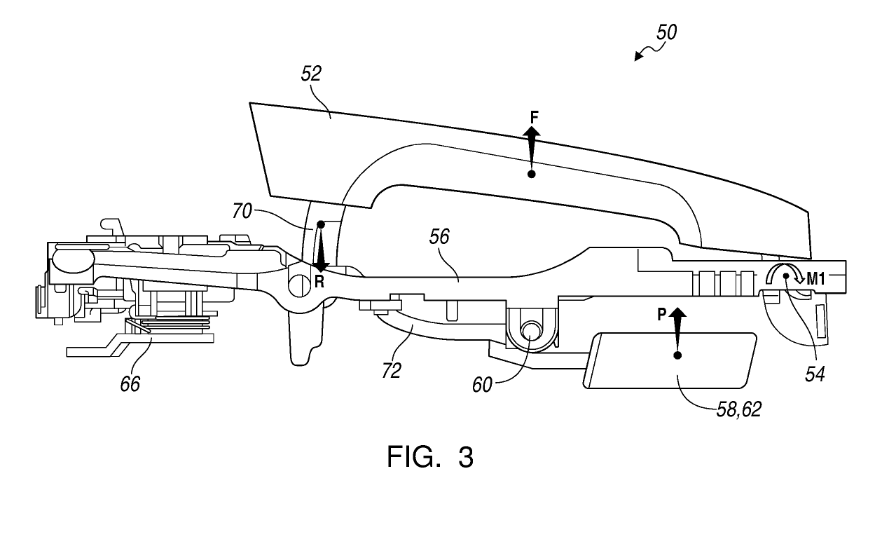

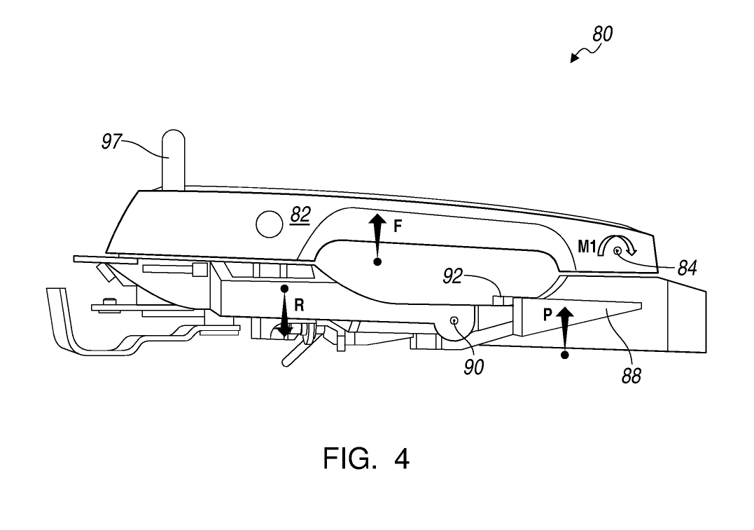

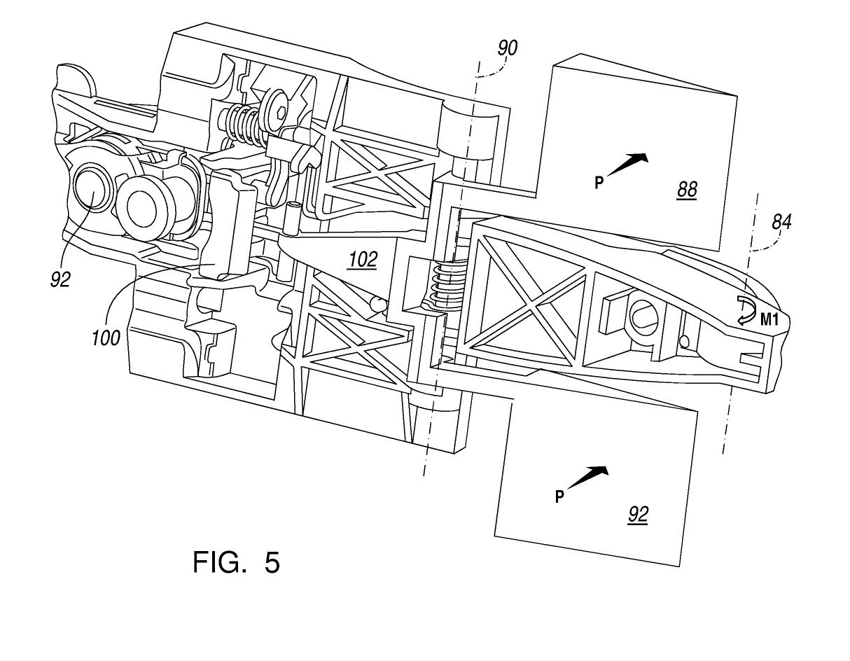

FIG. 2 is an inboard view of a second embodiment of a door handle assembly 50 for a passenger side door showing the door paddle 52 pivoted outboard about its pivot axis 54. FIG. 3 is a top view of FIG. 2. A bracket 56, which is bolted to the inside of the door, supports the door paddle 52 at axis 54, an upper mass 58 and lower mass 62 at their pivot axis 60. A key cylinder lever 66 rotates in response to rotation of a door key to lock and unlock the door.

An actuation arm 70, secured to door paddle 52 and extending through an opening in bracket 56, is continually engaged by an arm 72 formed integrally with the two masses 58, 62 and extending forward from axis 60.

In operation, when the door paddle 52 is pulled, actuation arm 70 moves outboard from the position shown in FIGS. 2 and 3, causing masses 58, 62 to pivot clockwise about axis 60, and the door paddle to pivot clockwise about axis 54.

In the event of a vehicle impact event, lateral acceleration of the door paddle relative to the bracket 56 produces outboard directed inertia force F on door paddle 52 and a clockwise moment M1 about axis 54. Lateral acceleration also produces outboard inertia force P on masses 58, 62, which pivots the masses about axis 60, applies an inboard reaction R on actuation arm 70 and a counterclockwise moment about axis 54, which is balanced by the clockwise moment M1 produced by outboard inertia force on the door paddle 52. Because these moments are equal in magnitude and opposite in direction, the door paddle 52 remains stationary. The counter balanced masses 58, 62 are arranged such that they do not cause vertical inertia and produce very high G-force capacity in any direction of the inertia forces.

While certain embodiments of the present invention have been described in detail, those familiar with the art to which this invention relates will recognize various alternative designs and embodiments for practicing the invention as defined by the following claims.

What is claimed is:

1. A door handle assembly for use with a vehicle door comprising:
a door paddle including an actuation arm, supported to pivot about a first axis such that lateral acceleration of the paddle and actuation arm relative to the door produces a first moment about the first axis;
a first mass engaged with the actuation arm and supported to pivot about a second axis; and
a second mass engaged with the actuation arm and supported to pivot about a third axis, the masses being arranged such that lateral acceleration of the masses relative to the door produces a second moment about the first axis that is substantially equal in magnitude and opposite in direction to the first moment.

2. The assembly of claim 1 wherein the first axis is substantially vertical and the second and third axes are substantially horizontal.

3. The assembly of claim 1 wherein the first axis is substantially perpendicular to the second and third axes.

4. The assembly of claim 1 wherein the first, second and third axes are substantially vertical.

5. The assembly of claim 1 wherein the first, second and third axes are mutually parallel.

6. A door handle assembly for use with a vehicle door comprising:
a door paddle including an actuation arm, supported to pivot about a first axis such that lateral acceleration of the paddle and actuation arm relative to the door produces a first moment about the first axis;
first and second masses engaged with the actuation arm and supported to pivot about a second axis, the masses being arranged such that lateral acceleration of the masses relative to the door produces a second moment about the first axis that is substantially equal in magnitude and opposite in direction to the first moment.

7. The assembly of claim 6 further comprising:
an arm secured to the masses, supported to pivot about the second axis, and engaged with the actuation arm.

8. The assembly of claim 6 further comprising:
a bracket securable to the door, the first and second axes being supported on the bracket; and
an arm secured to the masses, supported on the bracket to pivot, and engaged with the actuation arm.

9. The assembly of claim 6 further comprising:
an arm supported to pivot about the second axis, extending in a first direction from the second axis toward and supporting the masses, and extending in a second direction from the second axis toward and engaged with the actuation arm.

10. The assembly of claim 6 wherein the first, second and third axes are substantially vertical.

11. The assembly of claim 6 wherein the first, second and third axes are mutually parallel.

12. A method of operating a door handle assembly on a vehicle door comprising the steps of:
(a) pivotally supporting a door paddle and an actuation arm about a first axis such that lateral acceleration of the paddle and actuation arm relative to the door produces a first moment about the first axis;
(b) pivotally supporting a first mass engaged with the actuation arm to pivot about a second axis; and
(c) pivotally supporting a second mass engaged with the actuation arm to pivot about a third axis; and
(d) arranging the masses such that lateral acceleration of the masses relative to the door produces a second moment about the first axis that is substantially equal in magnitude and opposite in direction to the first moment.

13. The method of claim 12, wherein steps (c) and (d) further comprise locating the second axis and the third axis collinearly.

14. The method of claim 12, wherein:
step (a) further comprises locating the first axis in a substantially vertical plane;
step (c) further comprises locating the second axis in a substantially horizontal plane; and
step (d) further comprises locating the third axis in a substantially horizontal plane.

15. The method of claim 12, wherein:
step (a) further comprises locating the first axis in a substantially vertical plane; and
step (c) and (d) further comprise locating the second axis and third axis collinearly in a substantially horizontal plane.
